(19) United States
(12) Patent Application Publication
(10) Pub. No.: US 2005/0114191 A1
(43) Pub. Date: May 26, 2005

(54) Method and apparatus for a calendar system with a location functionality

(75) Inventors: Steven Edward Atkin, Austin, TX (US); Cornell G. Wright JR., Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/718,087

(22) Filed: Nov. 20, 2003

(51) Int. Cl. G06F 17/60

(52) U.S. Cl. 705/8

(57) ABSTRACT

A method, apparatus, and computer instructions for managing scheduling information in a calendar program. Location information with scheduling information for a user is stored. The location information includes a time zone associated with a location for the user for a particular day. A calendar view is presented for the user with meetings being shown using a local time using the time zone associated with the location of the user.

### BACKGROUND OF THE INVENTION

1. Technical Field

The present invention relates generally to an improved data processing system and in particular to a method and apparatus for managing data. Still more particularly, the present invention relates to a method, apparatus, and computer instructions for managing scheduling information for a calendar system.

2. Description of Related Art

Many users employ an electronic calendar to keep track of events. In particular, users employ calendars to keep track of meetings that may occur in different ways. Meetings traditionally took place on a face-to-face basis. Today, meetings may also take place in other ways. For example, a meeting may take place through a telephone conference, a video conference, or a chat session. These meetings are tracked using the calendar program. Additionally, with group calendaring, scheduling may be employed in which a user sets up a meeting with other potential participants. The potential participants are automatically emailed with messages indicating a proposed meeting time. At that point, the calendar program waits for responses from the potential participants.

Some users frequently travel or schedule meetings with those who travel. In this case, such a user must take into account time zone differences between the user's location and the participant's location. For example, if a participant requests a time at 10:30 a.m., the user's time may be 4:30 a.m. based on the time zone difference in the locations between the user and the participant. Further, the user also must determine whether the participant will travel to another location on the proposed meeting date. In such a case, the time zone may again change requiring adjustments for the user.

The present invention recognizes that current calendaring programs do not take into account location of the user and other users for a particular meeting date. Current systems only track the current time zone of the user. Therefore, it would be advantageous for an improved method, apparatus, and computer instructions for providing calendar functions that take travel by users and participants to different locations into account.

### SUMMARY OF THE INVENTION

The present invention provides a method, apparatus, and computer instructions for managing scheduling information in a calendar program. Location information with scheduling information for a user is stored. The location information includes a time zone associated with a location for the user for a particular day. A calendar view is presented for the user with meetings being shown using a local time using the time zone associated with the location of the user.

### BRIEF DESCRIPTION OF THE DRAWINGS

The novel features believed characteristic of the present invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in providing user location enhancements to a calendar program in accordance with a preferred embodiment of the present invention;

FIG. 5 is a diagram illustrating a graphical user interface for calendar functions in accordance with a preferred embodiment of the present invention;

FIG. 6 is a display of a schedule in accordance with a preferred embodiment of the present invention;

FIG. 7 is a flowchart of a process for displaying scheduling information in accordance with a preferred embodiment of the present invention;

FIG. 8 is a flowchart of a process for scheduling meetings in accordance with a preferred embodiment of the present invention;

FIG. 9 is a flowchart of a process for providing scheduling information in accordance with a preferred embodiment of the present invention; and

FIG. 10 is a flowchart of a process for presenting scheduling information in accordance with a preferred embodiment of the present invention.

### DETAILED DESCRIPTION OF THE PREFERRED EMBODIMENT

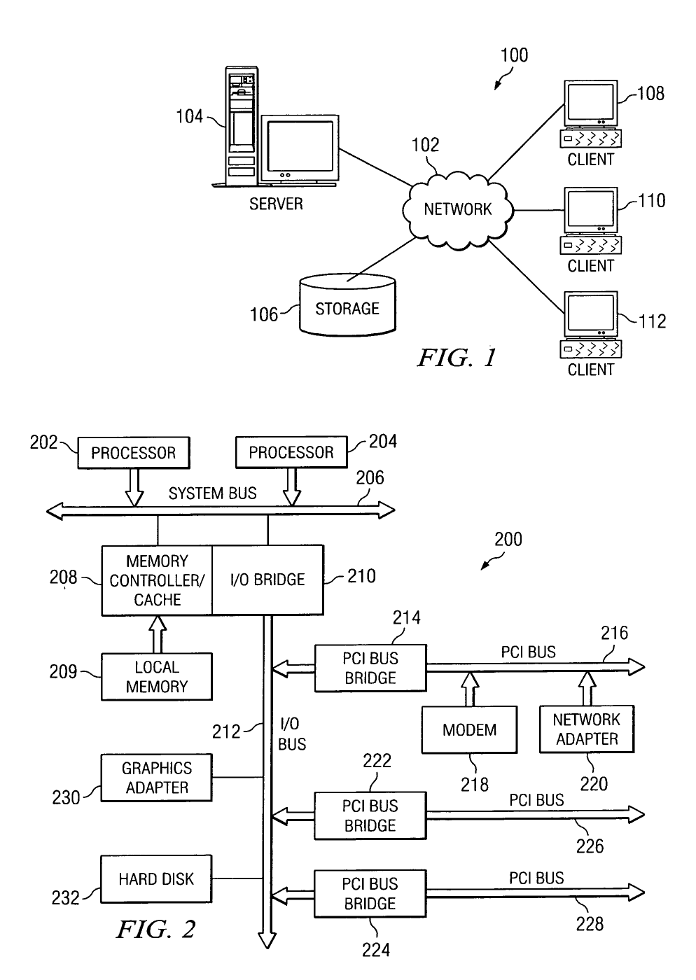

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

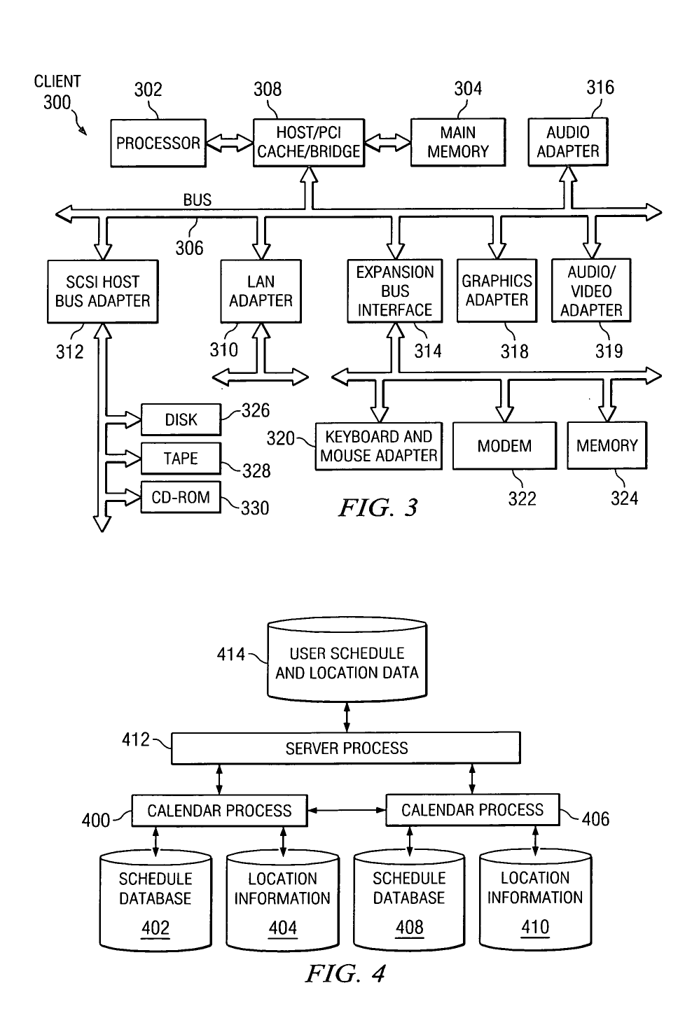

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for scheduling meetings in which a location and time zone of a user and other participants are taken into account. This mechanism provides a calendar feature that is currently unsupported by current calendar programs. The calendar program of the present invention may include various functions that take the location and time zone of different users into account.

In the illustrative embodiment, a planned location for each calendar user, on each day, is maintained by the calendar process. This feature allows scheduling that takes into account the planned location of users and participants in addition to available times. In this manner, meetings may be automatically scheduled for times when participants are in the same location. Also, with the maintaining of stored location information, a calendar may indicate local times for each user based on the time zone of the location of the user on a particular day.

In this manner, meetings for participants in multiple time zones may be arranged in a manner that is most convenient for all of the participants. The local time zone for a planned location may be displayed on each user's calendar for a particular day based on future plans. As a result, information regarding times of meetings may be displayed with respect to a local time zone for a location on a future date even if the user is not currently at that location. Consequently, scheduling decisions may be made in view of the local time at a planned location. Also, the mechanism of the present invention may display local information, such as local workdays and normal business hours for a particular location. In the United States, for example, the business hours may be 9:00 a.m.-6:00 p.m., Monday through Friday. In Japan, however, the business hours may be 10:00 a.m.-8:00 p.m., Monday through Friday. Israel may have business days that are from 9:00 a.m.-5:00 p.m. Sunday through Thursday, plus Friday morning. Further, holidays for each planned location of a particular user also may be indicated for a particular user. In this manner, the user may schedule meetings that correspond with respect to local business practices.

With reference now to FIG. 4, a diagram illustrating components used in providing user location enhancements to a calendar program is depicted in accordance with a preferred embodiment of the present invention. In this example, calendar process 400 provides calendaring functions to schedule meetings, tasks and other events. Calendar process 400 may be implemented using a calendar program such as, for example, Microsoft Outlook, which is available from Microsoft Corporation, and Lotus Notes, which is available from International Business Machines Corporation. In this example, the different meetings, tasks, and other events are stored in schedule database 402. Additionally, in the illustrative embodiment, location information 404 is information also stored by calendar process 400. This information is stored in a separate file or database in these examples, but may be combined into a single file or database with schedule data 402 depending on the particular implementation.

Calendar process 400 may receive location information from other participants. For example, a participant at calendar process 406 may send scheduling data and location information from schedule database 408 and location information 410. This information may be used by the user at calendar process 400 to set up a meeting such as on a time when both users are in the same location. Further, this exchange of information between calendar process 400 and 406 may allow for different users to schedule meetings for a time that is most convenient for the different participants. With the location information of each user, a user at calendar process 400 may select a desired time for a meeting. With this selected time, the user at calendar process 400 may see the corresponding time for the user at calendar process 406.

In one illustrative example, a user at calendar process 400 is located in London, while a user at calendar process 406 is located in the United States. If the user at calendar process 400 selects a 10:00 a.m. meeting time, calendar process 400 displays the corresponding meeting time with respect to the location of the user at calendar process 406. In this example, the meeting time would then be 4:00 a.m. As a result, the user may adjust the meeting time to a later time to provide for a more convenient time for both users. Such a feature is especially useful when the number of participants in a meeting increases beyond two.

In addition to exchanging schedule and location information directly between calendar process 400 and calendar process 406, a server containing server process 412 may be implemented to allow for a central management of calendar functions. In this example, users schedule data and location information 414 is employed to store schedule information and location information for different client processes, such as calendar process 400 and calendar process 406. Such a configuration allows for Web-based calendar systems as well as reducing the amount of space needed to store information on a client. Server process 412 may be implemented in a server, such as data processing system 200 in FIG. 2.

Calendar process 400 and calendar process 406 may be implemented in a client computer, such as data processing system 300 in FIG. 3.

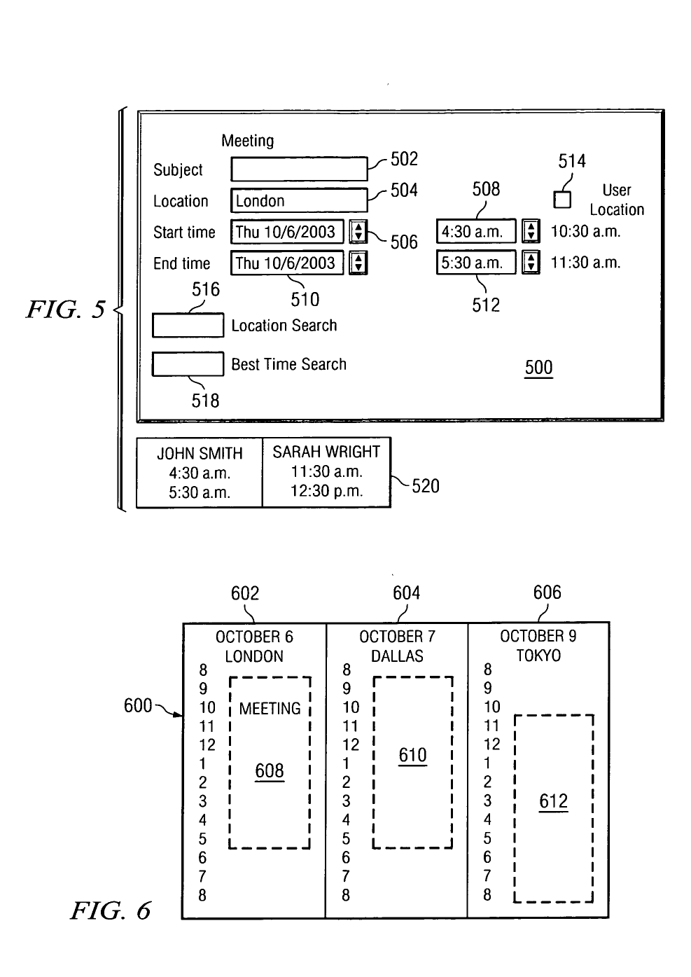

Turning now to FIG. 5, a diagram illustrating a graphical user interface for calendar functions is depicted in accordance with a preferred embodiment of the present invention. In this example, window 500 provides an interface to a calendar process for a user to schedule meetings. This interface may be used in a calendar process such as calendar process 400 in FIG. 4.

As illustrated, the user may enter a subject for the meeting in subject field 502. Further, the user may enter location information as to the location of the user for a particular date in location field 504. The start time for a meeting is indicated in data field 506 and time field 508. The end time for a meeting is indicated in date field 510 and time field 512.

In this example, the user has selected 4:30 a.m. start time and a 5:30 a.m. end time based on the location of another user to accommodate schedules. This time, however, is based on the user's present location. The location that the user has entered in location field 504 is different location from the user's current location. The calendar process displays within window 500 the time of the meeting based on the user's location for that date as being 10:30 a.m. and 11:30 a.m. This information may be displayed within the user's calendar by selecting button 514, which is an option to display the time relative to the user's planned location. Additionally, in some cases the location also may result in a change in the date. In this case, the date change also may be displayed in the user's calendar. This option may be presented within window 500 in a manner similar to that provided by button 514.

Further, window 500 provides for an ability to search for times during which the user and planned participants are in the same physical location. This feature may be initiated by selecting button 516 to initiate a location search. To identify the best time for the user and different participants, a selection of button 518 results in pop-up window 520 being displayed. Button 518 provides for a best time search to display the local time for each potential participant on the proposed date.

In this example, the time for John Smith is 4:30 a.m. to 5:30 a.m. on the date selected by the user in window 500. The time for Sarah Wright is 11:30 a.m. to 12:30 p.m. based on the selected time. In this manner, a user may identify times that are most convenient for all of the participants based on the location of each participant for the proposed time. This feature in enabled by storing location information for each participant. In this manner, the location of a participant for a particular time in the future may be taken into account in scheduling meetings. Again, these meetings may take place in various forms, such as, for example, through a face-to-face meeting, a telephone conference, a video conference, or a chat session.

Turning now to FIG. 6, a display of a schedule is depicted in accordance with a preferred embodiment of the present invention. Screen 600 is an example of a display generated by a calendar process, such as calendar process 400 in FIG. 4. In this example, screen 600 includes days 602, 604, and 606 in which each day presents scheduling information for a user.

Further, each day also indicates location information as to the location of the user on that particular day. For example, the user is located in London on day 602, in Dallas on day 604, and in Tokyo on day 606. Each of these days display hours for a day.

Further, local workdays and normal business hours may be displayed within screen 600. For example, during day 602, section 608 indicates that the business hours for the user are from 9:00 a.m. to 5:00 p.m. when the user is located in London. Similar business hours are shown for the user on day 604 when the user is in Dallas in section 610. On day 606, the business hours are identified as being from 10:00 a.m. to 8:00 p.m. in section 612 when the user is located in Tokyo.

In this manner, the user may schedule meetings based on the local workdays for the locations at which the user will be found on those particular dates. Further, holiday information for each location also may be indicated.

Additionally, the scheduled time for a meeting may be shown in the local time in screen 600 in response to a user selecting a user location option, such as through button 514 in FIG. 5. Through this option, the local time for the planned location may be displayed on screen 600 even though the user is not in that location at the current time. For example, if the user has scheduled a meeting for 4:00 a.m. based on the user's current location, that meeting may be displayed as being 10:00 a.m. on day 602 when the user travels to London. The 10:00 a.m. meeting time is displayed instead of a 4:00 a.m. meeting time to reflect the fact that the user will be present in London and initiating the meeting at 10:00 a.m. London time, rather than 4:00 a.m., which is the current time in Dallas for the user.

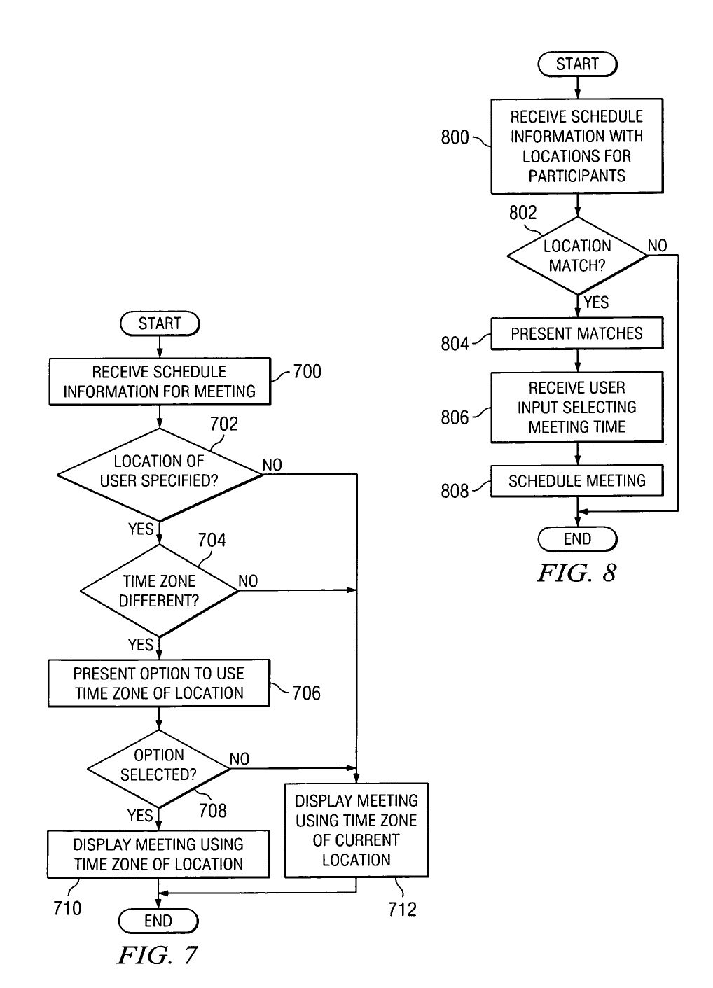

Turning now to FIG. 7, a flowchart of a process for displaying scheduling information is depicted in accordance with a preferred embodiment of the present invention. The process illustrated in FIG. 7 may be implemented in a calendar process, such as calendar process 400 in FIG. 4.

The process begins by receiving scheduling information for a meeting (step 700). This information may be obtained from a database, such as schedule database 402 in FIG. 4 or from another user attempting to schedule a meeting. Thereafter, a determination is made as to whether the location of the user has been specified (step 702). This location information may be found in location information 404 in FIG. 4 in the illustrative examples. If location information for the user is specified, a determination is made as to whether the time zone of the user is different for the scheduled meeting (step 704). The determination in step 704 is made by comparing the time zone for the user's current location with the time zone for the location of the user at the time of the scheduled meeting.

For example, if the user is currently located in Dallas, and the user will be in London for the time of the meeting, then the time zone is different. If the time zone is different, then an option is presented to the user to use the time zone of the location at the meeting time (step 706). This option may be presented to the user through a graphical user interface, such as window 500 in FIG. 5.

Next, a determination is made as to whether this option has been selected (step 708). If the option is selected, then the meeting is displayed using the time zone of the location (step 710) with the process terminating thereafter. The display in step 710 is made in a screen, such as screen 600 in FIG. 6 using the local time based on the location of the user on the date of the meeting, rather than the current location of the user.

With reference again to step 708, if the option was not selected by the user, then the meeting is displayed using the time zone of the current location (step 712) with the process terminating thereafter. The process also proceeds to step 712 from step 704, if the time zone is not different between the user's current location and the user's location at the meeting time. With reference again to step 702, if the location of a user is not specified, then the process also proceeds to step 712.

Turning now to FIG. 8, a flowchart of a process for scheduling meetings is depicted in accordance with a preferred embodiment of the present invention. The process illustrated in FIG. 8 may be implemented using a calendar process, such as calendar process 400 in FIG. 4.

The process begins by receiving schedule information with locations for the participants (step 800). This information may be received from the calendar processes for the participants or from a central server process depending on the particular implementation. The schedule information identifies the location for participants on different days.

A determination is then made as to whether a location match is present (step 802). This determination is made by comparing the locations for the participants for different times and determining whether the participants will all be in the same location for one or more times. If a location match is present, the matches are presented (step 804). User input is received selecting a meeting time (step 806). The meeting time is then scheduled (step 808) with the process terminating thereafter.

With reference again to step 802, if a location match is not present, the process terminates. In this manner, the mechanism of the present invention allows for scheduling of meetings between users when a face-to-face or in person meeting is desired. Using the location information, these meetings may be automatically scheduled without requiring lengthy exchanges as to times and locations between the different users.

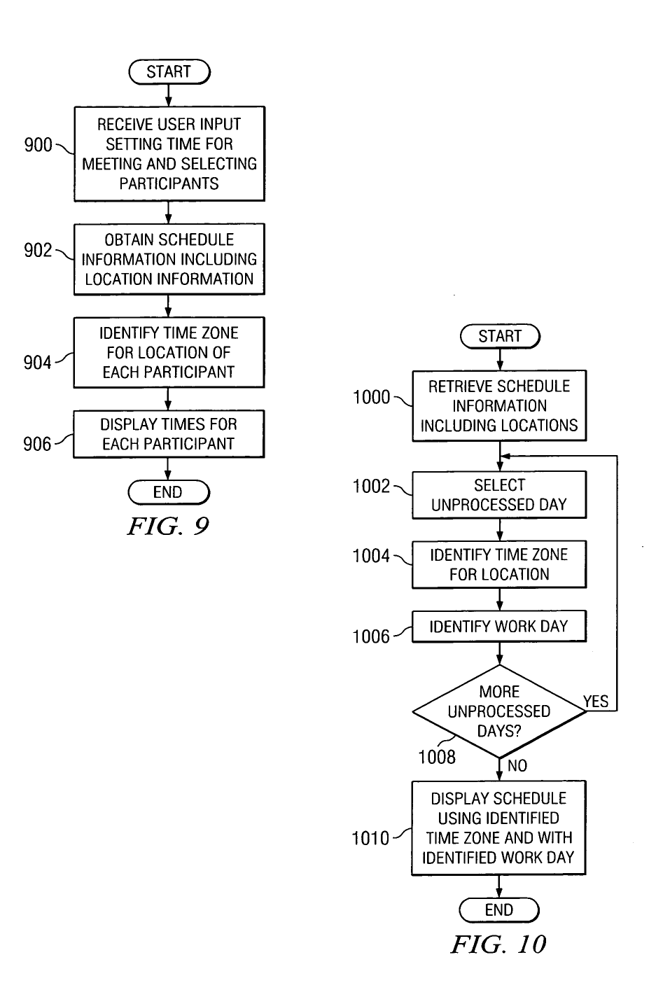

Turing now to FIG. 9, a flowchart of a process for providing scheduling information is depicted in accordance with a preferred embodiment of the present invention. The process illustrated in FIG. 9 may be implemented in a calendar process, such as calendar process 400 in FIG. 4.

The process begins by receiving a user input setting a time for the meeting and selecting participants (step 900). This user input may be implemented in a calendar process, such as calendar process 400 in FIG. 4 through a graphical user interface, such as window 500 in FIG. 5. Schedule information including location information is obtained for the participants (step 902). This information may be obtained by requesting the information from calendar processes for the participants or from a database of schedule information from a server depending on the particular implementation.

Thereafter, a time zone is identified for the location of each participant (step 904). With this time zone information, a local time may be identified for the participants. The local times are displayed for each participant (step 906) with the process terminating thereafter. This information may be displayed, such as using pop-up window 520 in FIG. 5. In this manner, a user may be able to see the actual local time for each participant in scheduling a meeting. In this manner, a convenient time for all the participants may be selected because the user is able to identify the local time for each participant based on the time selected by the user for a meeting.

Turning now to FIG. 10, a flowchart of a process for presenting scheduling information is depicted in accordance with a preferred embodiment of the present invention. The process illustrated in FIG. 10 may be implemented in a calendar process, such as calendar process 400 in FIG. 4, and displayed using a graphical user interface, such as screen 600 in FIG. 6.

The process begins by receiving schedule information including location information (step 1000). An unprocessed day is selected from the schedule information (step 1002). A time zone is identified for the location for the day (step 1004). The workday is then identified for that location (step 1006). A workday in these examples is the business hours for the particular location.

For example, the business hours for Dallas may be 9:00 a.m. to 5:00 p.m. while the business hours for Japan may be 10:00 a.m. to 8:00 p.m. A determination is then made as to whether more unprocessed days are present in the schedule information (step 1008). If additional unprocessed days are present, the process returns to step 1002 to select another day for processing. Otherwise, the schedule is displayed using the identified time zone and the identified workday (step 1010) with the process terminating thereafter.

Thus, the present invention provides an improved method, apparatus, and computer instructions for managing scheduling information. The mechanism of the present invention includes a location feature in the calendar process. Location information for a user is stored for different days such that the location of the user for a particular day may be identified in scheduling meetings. By identifying location information for the user and potential participants for a meeting, convenient meeting times may be identified as well as an ability to easily identify a common location for a physical or in-person meeting.

Further, this location information also allows for the display and presentation of meetings based on the local time that will be used by the user on that particular day. Also, the different business hours for different locations may be presented such that the user can more conveniently schedule meetings.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for managing scheduling information in a calendar program, the method comprising:
storing location information with scheduling information for a user, wherein the location information includes a time zone associated with a location for the user for a particular day; and
presenting a calendar view for the user with meetings being shown using a local time using the time zone associated with the location of the user.

2. The method of claim 1, wherein the user is present in multiple time zones for the particular day and wherein the calendar view includes local times for each of the multiple time zones.

3. The method of claim 1, further comprising:
obtaining location information for a set of potential participants for a meeting; and
responsive to the user selecting a proposed meeting time for the particular day, displaying the meeting time for a potential participant in the set of potential participants using a local time for the potential participant on the particular day.

4. The method of claim 3 further comprising:
obtaining location information for a potential participant for a meeting;
determining whether a day is present in which the user and the potential participant are in a common location; and
responsive to the day being present, scheduling a meeting between the user and the potential participant on the day.

5. The method of claim 1, wherein the presenting step includes:
displaying an indication of business hours for each day based on the location information.

6. The method of claim 1, wherein the obtaining step is initiated in response to the user identifying the set of potential participants.

7. The method of claim 1, wherein the presenting step includes:
displaying an indication of holidays based on the location information, wherein a holiday for a selected day is based on a location of the user on the selected day.

8. The method of claim 1, wherein the location information is stored locally in the data processing system.

9. A data processing system for managing scheduling information in a calendar program, the data processing system comprising:
storing means for storing location information with scheduling information for a user, wherein the location information includes a time zone associated with a location for the user for a particular day; and
presenting means for presenting a calendar view for the user with meetings being shown using a local time using the time zone associated with the location of the user.

10. The data processing system of claim 9, further comprising:
obtaining means for obtaining location information for a set of potential participants for a meeting; and
displaying means for displaying the meeting time for a potential participant in the set of potential participants using a local time for the potential participant on the particular day in response to the user selecting a proposed meeting time for the particular day.

11. The data processing system of claim 10 further comprising:
obtaining means for obtaining location information for a potential participant for a meeting;
determining means for determining whether a day is present in which the user and the potential participant are in a common location; and
scheduling means for scheduling a meeting between the user and the potential participant on the day in response to the day being present.

12. The data processing system of claim 9, wherein the presenting means includes:
displaying means for displaying an indication of business hours for each day based on the location information.

13. The data processing system of claim 9, wherein the obtaining means is initiated in response to the user identifying the set of potential participants.

14. The data processing system of claim 9, wherein the presenting means includes:
displaying means for displaying an indication of holidays based on the location information, wherein a holiday for a selected day is based on a location of the user on the selected day.

15. The data processing system of claim 9, wherein the location information is stored locally in the data processing system.

16. A computer program product in a computer readable medium for managing scheduling information in a calendar program, the computer program product comprising:
first instructions for storing location information with scheduling information for a user, wherein the location information includes a time zone associated with a location for the user for a particular day; and
second instructions for presenting a calendar view for the user with meetings being shown using a local time using the time zone associated with the location of the user.

17. The computer program product of claim 16, further comprising:
third instructions for obtaining location information for a set of potential participants for a meeting; and
fourth instructions for displaying the meeting time for a potential participant in the set of potential participants using a local time for the potential participant on the particular day in response to the user selecting a proposed meeting time for the particular day.

18. The computer program product of claim 17 further comprising:
first sub-instructions for obtaining location information for a potential participant for a meeting;
second sub-instructions for determining whether a day is present in which the user and the potential participant are in a common location; and
third sub-instructions for scheduling a meeting between the user and the potential participant on the day in response to the day being present.

19. The computer program product of claim 16, wherein the second instructions includes:
sub-instructions for displaying an indication of business hours for each day based on the location information.

20. The method of claim 16, wherein the location information is stored locally in the data processing system.
